(19) United States
(12) Patent Application Publication
(10) Pub. No.: US 2012/0272302 A1
(43) Pub. Date: Oct. 25, 2012

(54) Human User Verification

(75) Inventors: Bin Benjamin Zhu, Edina, MN (US); Qiang Dai, Beijing (CN)

(73) Assignee: Microsoft Corporation, Redmond, WA (US)

(21) Appl. No.: 13/091,964

(22) Filed: Apr. 21, 2011

(51) Int. Cl. H04L 9/32; G06K 9/34

(52) U.S. Cl. 726/6; 382/173

(57) ABSTRACT

Techniques for generating a human user test for online applications or services may include splitting the visual objects in an image into multiple partial images, and forming one or more alignment positions. At each of the alignment positions, some of the visual objects appear recognizable while some bogus visual objects also appear to prevent robots from recognizing the alignment positions. A user is requested to find the multiple alignment positions to return recognizable visual objects. A system determines that the user is a human user if the recognizable visual objects input by the user match the visual objects in the image.

### BACKGROUND

More and more applications or services have been moved online. Online services such as web email services, online voting, social network websites, and posting are designed to interact with valid human users. Very often, however, malicious users employ automated computer programs (referred to as “robots”) to pretend to be human users to abuse the online services. For example, robots have been used to sign up new email accounts to send spam emails, to post at web blogs and forums, and to vote in online voting. Alternatively, the malicious users may employ persons with low labor costs (referred to as “cheap laborers”) to sign up a large volume of accounts to abuse the online services. There is a challenge to verify whether a user is a valid human user.

Some techniques, such as completely automated public Turing test to tell computers and humans apart (“CAPTCHA”), also known as Human Interactive Proof (“HIP”), have been proposed to identify valid human users. Traditional CAPTCHA techniques present a simple test such as recognizing distorted characters. A user who can submit the correct characters is presumed to be a human user; otherwise the user is deemed as an invalid user and rejected for the online services.

There is a dilemma of the traditional CAPTCHA techniques based on recognition of the distorted characters, however. On one hand, if the distortion is not severe enough, the artificial intelligence techniques can make the robots easily identify the characters or the cheap laborers can spend very little time to obtain the correct characters. On the other hand, if the distortion is severe, such distortion would also make it difficult for a valid human user to recognize individual characters and cause frustrations of user experiences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the present disclosure.

The present disclosure describes techniques for identifying human users for applications or services. In one example, a computing system obtains an image including one or more visual objects, and then splits the one or more visual objects in the image into multiple partial images. The computing system can generate the image or receive the image from a third party, such as an image database. The one or more visual objects in the image are unknown to the user.

Each partial image includes a part of the one or more visual objects. The computing system may further process one or more of the partial images, such as rearranging relative positions between the partial images or relative positions between segments in one partial image, to define one or more alignment positions between the partial images. When the partial images are aligned at the one or more alignment positions, a portion or all of the original visual objects appear. When there are multiple alignment positions, at each alignment position, a portion of the visual objects appears recognizable while another portion of the visual objects does not appear recognizable.

The resulting partial images, after completion of processing, are then available to a user at a user interface, and the user may move the partial images to find the alignment positions to obtain one or more recognized visual objects. In one example, the user needs to find all of the alignment positions to recognize the originally generated visual objects. The correctness of recognizing all the visual objects obtained from alignment of the partial images is checked against the ground truth, such as the one or more visual objects in the image, not known to the user. In an event that the recognition is correct, the user is determined to be a human user and the applications or services are then available to the user. In an event that the recognition is incorrect, the user is deemed to be an invalid user and the user is denied access to the applications or services. In one example, the correctness checking is implemented by asking the user to indicate, for example by inputting, all the visual objects the user recognizes. The computing system compares the user input with the originally generated one or more visual objects in the image. In an event that the two matches, the user input is correct. In an event that the two does not match, the user input is incorrect. Additionally, the order of the visual objects input by the user may also be checked against the order of the originally generated one or more visual objects in determining whether the user input is correct.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary overview for identifying a human user by requesting a user to align partial images to recognize characters in a network environment.

FIG. 2 is a flowchart showing an exemplary method of generating the human user verification test.

FIG. 3 shows an exemplary bounding box of each character in an image.

FIG. 4 shows exemplary potential splitting points extracted from the characters in the image.

FIG. 5 shows several exemplary alternatives to cut at a connection point of an exemplary character in the image.

FIG. 6 shows an exemplary example of two resulting partial images.

FIG. 7 shows an exemplary grouping result of segments in a partial image by applying the character bounding boxes information.

FIG. 8 shows an exemplary result after shrinking or extending the ends of segments of characters.

FIG. 9 shows an exemplary result of treating a first image as the background image and processing a second partial image to obtain a foreground image.

FIG. 10 shows an exemplary display of the human user verification test to the user on a user interface.

FIG. 11 illustrates an exemplary computing system usable to generate a human user test.

### DETAILED DESCRIPTION

### Overview

The present disclosure describes techniques for verifying whether a user is a human user before allowing the user to access an application or service. The techniques request a user to find one or more alignment positions of multiple partial images and to align the multiple partial images at each of the one or more alignment positions in order to correctly recognize the visual objects in the multiple partial images.

For example, a computing system may obtain an image including one or more visual objects, and randomly split the one or more visual objects into multiple partial images. The computing system may either generate the image or receive the image from a third party such as an image database.

The number of partial images may be two or more. Each partial image contains part of the visual objects. In one example, each partial image contains part of each of the visual objects. For instance, if the one or more visual objects are characters “ABC,” then each partial image contains part of a character “A,” a character “B,” and a character “C.”

In another example, each partial image contains part of one of the visual objects. For instance, if the one or more visual objects are a jigsaw including multiple visual objects, then each partial image may be just a piece of one of the visual objects. If the one or more visual objects are characters “ABC,” then each partial image contains part of either the character “A,” the character “B,” or the character “C.”

In yet another example, a partial image may contain a whole or none of the one or more visual objects. For instance, if the one or more visual objects are characters “ABC,” then one partial image may contain the whole part of the character “A,” and another partial image does not contain any part of the character “A.”

The computing system may present the multiple partial images to a user at a user interface and request the user to align the multiple partial images at the one or more alignment positions to obtain one or more recognized visual objects. The user returns the one or more recognized visual objects to the computing system.

When the multiple partial images are correctly aligned at each of the alignment positions, at least a portion of the visual objects appear recognizable. At positions other than the alignment positions, at least a portion of the visual objects do not appear recognizable.

The computing system compares the recognized visual objects with the visual objects in the original image to determine whether the recognized visual objects match the visual objects in the original image. The computing system may use different criteria for determination of a match.

In one embodiment, if the recognized visual objects are identical with the visual objects in the original image, the computing system may determine that recognized visual objects match the one or more visual objects.

In another embodiment, even if the recognized visual objects are not identical to the visual objects in the original image (e.g., if the recognized visual objects are similar to the one or more visual objects in the original image), the computing system may still determine that the recognized visual objects match the visual objects. For example, the computing system may recognize a match if one of the visual objects is a character “O” while the recognized visual object is a number “0.” The character “O” and the number “0” are similar, so that the computing system still determines that there is a match. For another example, if the recognized visual objects and the one or more visual objects have multiple common objects, the computing system may still determines that there is a match. For instance, if the visual objects are “ABCDE” while the recognized visual objects are “ABCDF”, as the visual objects and the recognized visual objects share multiple common visual objects in order, the computing system may still determine that there is a match.

In one example, the set of the recognized visual objects are compared with the set of the visual objects in the original image to determine if they match each other. The order of the visual objects may be excluded from the comparison in determining a match or not. For instance, if the visual objects are “ABCDE” while the recognized visual objects are “CDEAB”, the computing system may determine that there is a match since the order of the visual objects are not considered in determining if there is a match or not in this case. For another instance, it is possible that the visual objects in the image are not arranged in order so that there is no need to compare the order between the visual objects and the recognized visual objects. The exemplary visual objects in the original image may be arranged around a circle such that there is no order for the visual objects.

In another example, the order of visual objects input by the user may also be compared with the original order of the visual objects to determine whether the recognized visual objects match the visual objects. For instance, if the visual objects are “ABCDE” while the recognized visual objects are “AECDB”, even though the visual objects and the recognized visual objects share multiple common visual objects but in wrong order, the computing system may still determine that there is not a match.

The computing system may establish a threshold of similarity needed to be considered a match. For instance, the threshold may be a number (or percentage) of correct visual objects contained in the recognized visual objects, or a number of correctly ordered visual objects contained in the recognized visual objects.

The computing system may define the one or more alignment positions where two or more of the partial images can be aligned to present at least a portion of the one or more visual objects.

When there is one alignment position, the one or more visual objects are recognizable when the multiple partial images are aligned at the alignment position.

When there are multiple alignment positions, at each alignment position, at least a portion of the visual objects are recognizable when two or more of the multiple partial image are aligned. In one example, although a portion of the visual objects are recognizable at one of the alignment positions, another portion of the visual objects may still appear unrecognizable. In that case, the aligned multiple partial images also present unrecognizable visual objects in addition to the portion of the recognizable one or more objects. Thus, a user needs to find each of the multiple alignment positions to obtain different portions of the visual objects, and then combine all of the obtained potions to obtain the visual objects.

The techniques thus introduce a large set of bogus visual objects at each alignment position and increase the recognition difficulty for robots.

The computing system may control a complexity of the obtained visual objects in the image or the split partial visual objects or provide some instructions to the user on the user interface so that the user is capable of recognizing the visual objects within a reasonable time.

The described techniques prevent robots from learning the difference between a “neat state,” in which some or all visual objects are correctly aligned and thus recognizable, and a “messy state,” in which the one or more visual objects are split into different partial images and at least a portion of visual objects are not recognizable. In contrast, human users usually have a superior capability to identify legitimate visual objects from interleaving bogus objects that robots lack.

The techniques described herein are used to identify whether the user is a human. In addition, such techniques may also be helpful to reduce incentives to employ cheap laborers to abuse the online service. The techniques increase the time cost and attention for cheap laborers as they have to correctly align the partial images. The modestly increased time for completing a single human user verification test can still be within a reasonable time range without frustrating user experiences. However, an accumulation of increased time for completing a large volume of tests would substantially increase the time costs of the cheap laborers and make the cheap laborers feel exhausted; and thus become a hurdle to the malicious users that employ cheap laborers.

The techniques described herein may have many varied embodiments. For example, the visual objects may have various representations. In one embodiment, the visual objects are characters. The characters may include letters, such as English capitalized or non-capitalized alphabets A-Z, and numbers, such as Arabian numbers 0-9. The characters may also include any other characters, such as symbols like question mark “?” that can be input by the user from a keyboard. In one example, one or more of the characters are special texts, such as Chinese characters “ [symbol] ” (which means China in English) or other foreign language characters, which may not be found on buttons of a QWERTY-type keyboard. In the latter case, the computing system may generate a display window at the user interface and display multiple characters including the special texts at the display window. The user may click to choose the characters in the display window as an input of the recognized characters. The display window may act as a supplement to the keyboard or as a sole input tool that the user can use to input the recognized characters regardless of whether the user can find the recognized characters at the keyboard. Alternatively, a specific input application may be applicable to the user to expand functionality of the keyboard. For example, the user can use a Chinese input application to input the Chinese characters through the keyboard on a user interface.

In another embodiment, the visual objects may be pictures such as pictures of fruit. The techniques that the user uses to input answers may also be adjusted accordingly. For example, the computing system may request the user to find the visual objects correctly aligned at one or more alignment positions. When the user moves one or more of the partial images against each other, at least a portion of the picture becomes recognizable at each of the one or more alignment positions. For another example, the computing system may display several pictures in the display window and request that the user choose one or more recognized pictures from the several pictures.

In addition, the visual objects may be in either two-dimensions (2D), three-dimensions (3D), or potentially a greater number of dimensions.

The computing system may also arrange the visual objects in different orders in the generated image. For example, the visual objects may be placed horizontally, vertically, or radially around a ring in the image. Correspondingly, the computing system permits the user to move the partial images along a horizontal direction, a vertical direction, or in a circular manner respectively. In one example, the computing system also compares the order of visual objects input by the user with the original order of the visual objects in additional to requiring the user to recognize a number of correct visual objects.

Some or all of the operations discussed herein may be performed by different computing systems, and a result of an operation from one computing system may be used by another computing system.

### Exemplary Embodiment to Recognize Characters

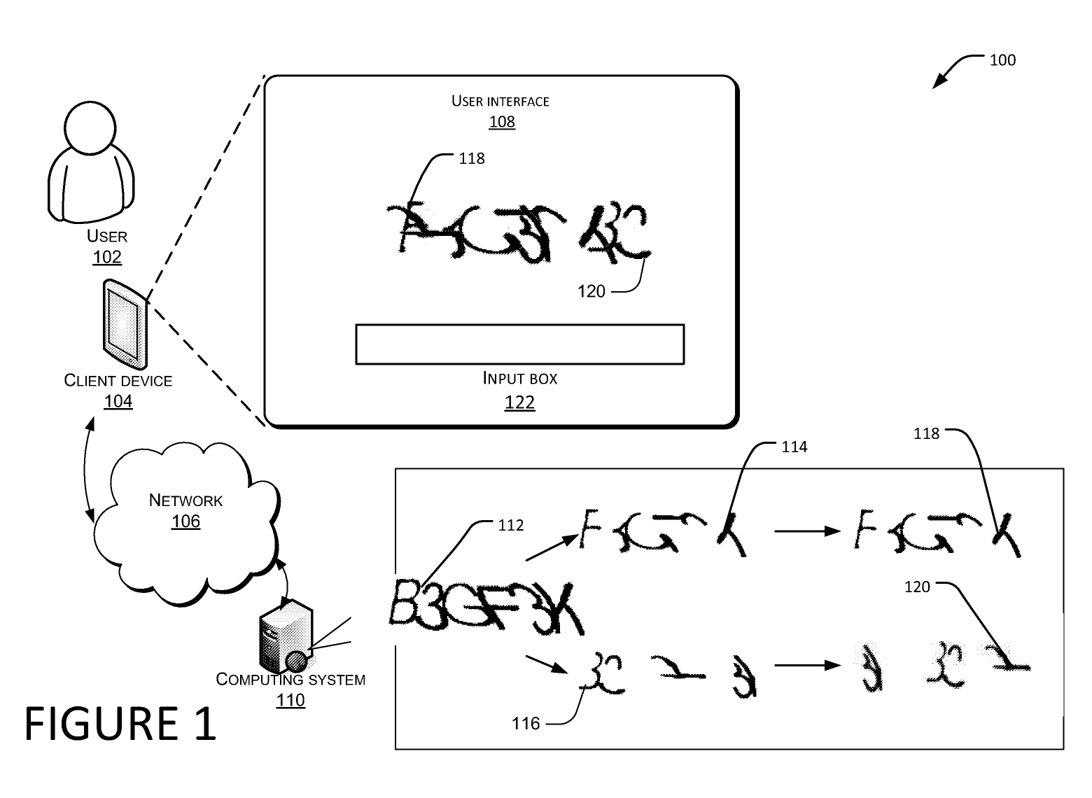

FIG. 1 illustrates an exemplary overview 100 for identifying a human user by requesting a user 102 to align multiple partial images to recognize characters in a network environment. In this embodiment, the visual objects are characters. In other words, this embodiment provides a text challenge to the user to find correct characters. For example, the user may be required to correctly identify a correct order of the characters in addition to the correct characters in the text challenge.

As shown in FIG. 1, a user 102 uses a client device 104 to request to access an online application or service (not shown) through a network 106. The client device 104 presents a user interface 108 to the user 102. The user interface 108 may be a web page displayed by a web browser as shown in FIG. 1. Before the online service is available to the user 102, a computing system 110 generates a human user verification test. The computing system 110 may be the same as, or independent from, the computing system that provides the online service. The user 102 has to pass the test to access the online application or service.

The client device 104 may be implemented as any one of a variety of conventional computing devices such as, for example, a desktop computer, a notebook or laptop computer, a netbook, a tablet or slate computer, a surface computing device, an electronic book reader device, a workstation, a mobile device (e.g., smartphone, personal digital assistant, in-car navigation device, etc.), a game console, a set top box, or a combination thereof The network 108 may be either a wired or a wireless network. The configuration of the computing system 110 is discussed in detail below.

The computing system 110 obtains an image 112 including a plurality of characters. The computing system 110 may either generate the image 112 or receive the image 112 from a distinct third party, such as an image database or a separate machine that generates the image 112. For example, the image 112 may be a text challenge, including characters to be identified by the user 102, generated and used for a traditional text CAPTCHA.

In FIG. 1, the image 112 includes characters “B3GF3K.” The characters in the image 112 may have some distortion and strokes of one or more of the characters may be connected. The image 112 may be generated for the purpose that the characters in the image 112 may be easily identified by a human user but difficult for robots. The image 112 is not available to the user 102.

The computing system 110 then splits the characters, such as “B3GF3K” in the image 112, into multiple partial images. In FIG. 1, the computing system 110 splits the characters into two partial images, i.e., a first partial image 114 and a second partial image 116. Each of the first partial image 114 and the second partial image 116 contains partial strokes of the characters in the image 112. The computing system 110 chooses one of the partial images, such as the first partial image 114, as a background image 118 and outputs the background image 118. In this example, there is no further processing of the first partial image 114 to be treated as the background image 118.

In one embodiment, the computing system 110 may use the first partial image 114 as a background image 118; use the second partial image 116 as a foreground image 120; and defining one alignment position to align the background image and foreground image to recognize the plurality of characters included in the image 112. In other words, the user 102 may only need to align the background image 118 and the foreground image 120 once to recognize the characters in the image 112.

In another embodiment as shown in FIG. 1 and detailed below, the computing system 110 may use the first partial image 114 as the background image 118, partition segments in the second partial image 116 into multiple groups, forms the foreground image 120 at least partly based on the partitioning, and defines multiple alignment positions to align the background image 118 and the foreground image 120 to recognize the plurality of characters included in the image. In other words, the user 102 may have to align the background image 118 and the foreground image 120 at each of the multiple alignment positions to obtain at least a portion of the characters in the image 112 and then combines different portions of the characters from different alignment positions to obtain all of the characters in the image 112.

The computing system 110 may further process one or more of the multiple images to form the foreground image 120. For example, in FIG. 1, the computing system 110 groups strokes of the partial characters in the second partial image 116 into a plurality of isolated groups based on a location of each character in the image 112 and a connectivity of the strokes. The computing system 110 then rearrange positions of the groups in the second partial image 116 to form the foreground image 120 and to define several alignment positions with the background image 118.

Both the background image 118 and the foreground image 120 are presented to the user 102 at the user interface 108. The user 102 is required to align the foreground image 120 with the background image 118 to recognize characters. In the example of FIG. 1, the user 102 then submits recognized characters in an input box 122 on the user interface 106.

In an event that the recognized characters match the characters in the image 112, the computing system 110 determines that the user 102 is a human user. The computing system 110 can use different techniques to determine that there is a match.

For example, in an event that the user 102 correctly recognizes or inputs the original characters in the image 112, i.e., “B3GF3K,” the computing system 110 determines that the recognized characters match the characters in the image 112.

For another example, the computing system 110 may set a threshold of similarity and may determine that there is a match if the recognized characters and/or an order of the recognized characters meet the threshold of similarity. For instance, the threshold is a number, such a majority, of correctly ordered characters in the recognized characters. If the recognized objects are “B3GF3H” instead of “B3GF3K,” the computing system 110 may still determine that the returned characters match the characters in the image 112 as the returned characters contain a majority of correctly ordered characters in the image 112.

Additionally or alternatively, the computing system 110 may maintain a listing of common mistakes made by humans (e.g., mistaking an “O” for a “0,” mistaking an “a” for an “o,” mistaking an “1” for a “1”, etc.) and may still find a match when such common mistakes exist.

The computing system 110 determines that the user 102 is a human user in response to determining that the recognized characters match the characters in the image 112. The online service is then available to the user 102.

Otherwise, the computing system 110 determines that the user 102 is probably a robot and the user 102 is denied access to the online service. The computing system 110 may allow the user 102 to input the recognized characters for a preset number of times if a prior input is wrong.

For convenience, the methods are described below in the context of the computing systems 110 and environment of FIG. 1. However, the techniques described herein are not limited to implementation in this environment.

The disclosed techniques may, but need not necessarily, be implemented using the computing system 110 of FIG. 1. For example, another computing system (not shown) may perform any one of the operations herein. It is not necessary that the computing system 110 alone complete any or all of the operations to generate the human user verification test. Also, as noted above, the computing system providing the online application or service and the computing system 110 providing human user verification test may be the same or different computing systems. The computing system 110 may or may not directly receive the request from or return the result to the user. For example, the computing system 110 may receive the request for the human user verification test and/or may return the result through a third party, such as a separate computing system providing the online application or service requested by the user 102.

Exemplary methods for performing techniques described herein are discussed in detail below. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote memories.

The exemplary methods are sometimes illustrated as a collection of blocks in a logical flow graph representing a sequence of operations that can be implemented in hardware, software, firmware, or a combination thereof The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer executable instructions that, when executed by one or more processors, perform the recited operations.

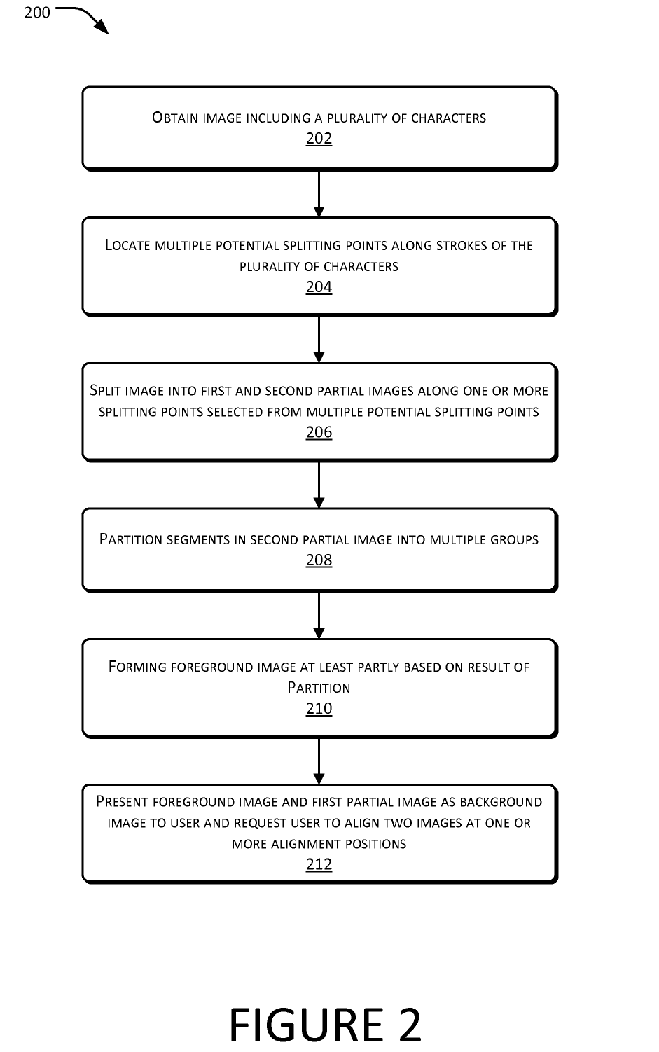

FIG. 2 is a flowchart showing an exemplary method 200 of generating the human user verification test.

At block 202, the computing system 110 obtains an image including a plurality of characters.

At block 204, the computing system 110 locates multiple potential splitting points along strokes of the plurality of characters.

At block 206, the computing system 110 splits the image 112 into multiple partial images along a group of splitting points selected from the multiple potential splitting points.

At block 208, the computing system 110 partitions segments in the second partial image 116 into multiple groups.

At block 210, the computing system 110 forms a foreground image 120 at least partly based on a result of the partitioning.

At block 212, the computing system 110 presents the first partial image 114 as a background image 118 and the foreground image 120 to the user 102, and requests the user 102 to align the two partial images at one or more alignment positions to recognize characters.

Referring back to block 202 of FIG. 2, the computing system 110 may distort and connect stokes of one or more of the characters. For example, the strokes of the characters may have various widths. The computing system 110 may preset or randomly create the distortion and connection of the characters within a preset extent. An example of the generated image is the image 112 including characters “B3GF3K” as shown in FIG. 1.

In the image 112, the letters B, 3, G, F, 3, and K are all distorted and not in print formats. Also, the characters are connected with the neighboring characters.

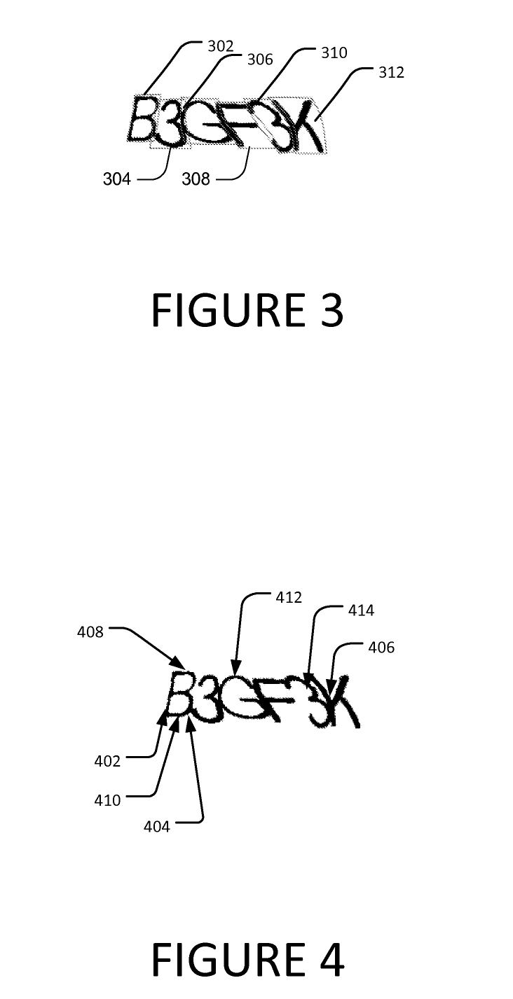

The computing system 110 may store a bounding box of each character in the image. FIG. 3 shows an exemplary bounding box of each character in the image 112. For example, the character “B” is within a bounding box 302, the character “3” is within a bounding box 304, the character “G” is within a bounding box 306, the character “F” is within a bounding box 308, another character “3” is within a bounding box 310, and the character “K” is within in a bounding box 312.

The computing system 110 is to use such stored bounding box information to partition the second partial image 116 into groups as discussed below.

Referring back to block 204 of FIG. 2, FIG. 4 shows exemplary potential splitting points extracted from the characters in the image 112.

A set of potential splitting points include one or more connection points, and one or more qualified non-connection points. The connection points, such as points 402, 404, 406, are where two or more strokes touch or cross each other.

The two or more strokes may come from one character, such as the point 402 in the character “B” and the point 406 in the character “K.” Alternatively, the two or more characters may come from different connected characters, such as point 404 where a stroke of the character “B” and a stroke of the character “3” are connected.

The non-connection points are internal points of strokes without touching or crossing other strokes. The computing system 110 may trace the connected thinned curves of the strokes to obtain the qualified non-connection points based on a curvature as well as a run length distance along a respective curve of the strokes. The computing system 110 may establish a predetermined threshold of the curvature and/or the run length distance from a most adjacent splitting point of a qualified non-connection point.

In an event that the curvature is greater than a predetermined threshold and/or the run length distance from an adjacent potential splitting point, such as a most adjacent potential splitting point, is larger than a predetermined threshold, the computing system 110 determines that such point is the qualified non-connection point.

Such qualified non-connect points, in the illustrated example, include points 408 and 410 in the character “B,” and the point 412 in the character “G.”

For example, to locate these potential splitting points, the computing system 110 may firstly thin the strokes of the characters and then segment the strokes to find connection points in the image 112. Such thinning and segmentation techniques may be obtained in accordance with technologies such as those described in Zhang, T. Y. and Suen, C. Y. 1984. A fast parallel algorithm for thinning digital patterns, Comm. of the ACM. 27(3) (March 1984), 236-239 and Elnagar, A. and Alhajj, R. 2003. Segmentation of connected handwritten numeral strings, Pattern Recognition. 36 (2003) 625-634, respectively.

The computing system 110 may ensure that each potential cut piece, obtained from a cut at the one or more potential splitting points from the characters, has a run length distance within a preset range. For example, the non-connection points with curvatures greater than the threshold, such as the two points 408 and 410 on the character “B” are selected as the qualified non-connection points since a cut at a large curvature point makes it hard for robots to trace the trends on resulting segments on both sides and to find a match to locating the splitting points.

The computing system 110 does not need to use any of prior known information about the characters or their locations in the image 112, such as the bounding box information of each character as shown in FIG. 3, to split the image 112. The computing system 110 uses public information, which the malicious users would also be able to obtain should the image 112 be available to the user 102 on the user interface 108, of the text challenge such as the image 112 to locate the potential splitting points and choose the splitting points. Therefore, the computing system 110 does not learn any information of the characters in the image 112 during splitting the characters in the image 112.

If the image 112 is available to the robots, the robots may also be able to deduce the potential splitting points including connection and non-connection points. It is difficult, however, for the robots to determine the potential splitting points and especially the actual splitting points chosen by the computing system 110 as there are many possibilities. The reverse process for the robots to find the image 112 from the multiple partial images is thus difficult.

The additional work for the robots to find the set of potential splitting points and the cut patterns actually used by the computing system 110 makes the security higher as compared to the case that the image 112 is directly presented to the user 102 as the text challenge.

In one example, the computing system 110 may exhaust all potential splitting points in FIG. 4. In another example, it is not necessary to exhaust all qualified potential splitting points and the computing system 110 may omit some qualified points such as a qualified non-connection point 414 in the character “3” left to the character “K.” Not all of the potential splitting points need to be used to split the image 112.

Referring back to block 206 of FIG. 2, the computing system 110 splits the image 112 into multiple partial images along a group of splitting points selected from the multiple potential splitting points. In one example, the computing system 110 splits the image 112 into the first partial image 114 and the second partial image 116 as shown in FIG. 1.

The computing system 110 firstly selects one or more splitting points from the multiple potential splitting points. The selection of the one or more splitting points can be a probabilistic process to avoid using fixed patterns in splitting the image 112. Connection points and qualified non-connection points with large curvatures may have a high probability to be selected. The cut at such a point would usually generate two dissimilar segments of the strokes so that the robots cannot trace the trends of both sides to detect a match in order to locate the splitting point.

The computing system 110 then cuts the image 112 at the one or more splitting points. There are various cut techniques to accomplish the goal.

For example, the computing system 110 may cut a non-connection point in any direction unparallel along the curve of the stroke. The computing system 110 may also cut the non-connection point in a direction within a preset range of angles to the normal direction at the non-connection splitting point.

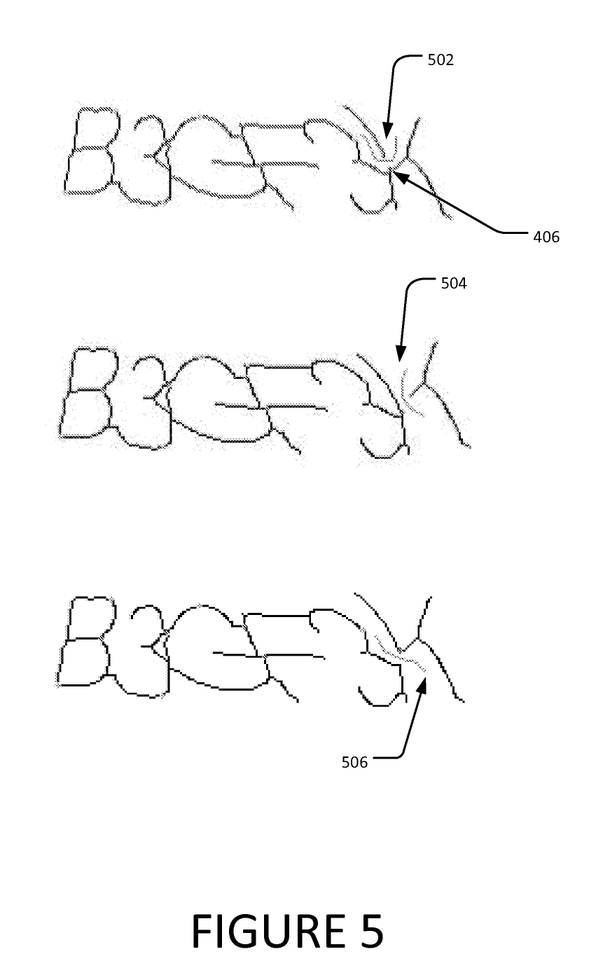

There are also several possible ways or directions to cut the connection points. FIG. 5 shows several alternatives to cut at the connection point 406 of an exemplary character such as “K” in the image 112. Each of arrows 502, 504, and 506 shows a possible direction to cut the connection point 406. The computing system 110 may choose one direction according to an extent of dissimilarity of the resulting two split parts. In the example of FIG. 5, the computing system 110 may choose the direction indicated by arrow 506 that results in two most dissimilar segments among the alternative directions. Such techniques also increase the difficulty for robots to find the splitting points.

After the computing system 110 determines the splitting points and the directions to cut at each splitting point, the computing system 110 cuts the image 112 into multiple segments accordingly. The computing system 110 then partitions the resulting multiple segments into two partial images 114 and 116.

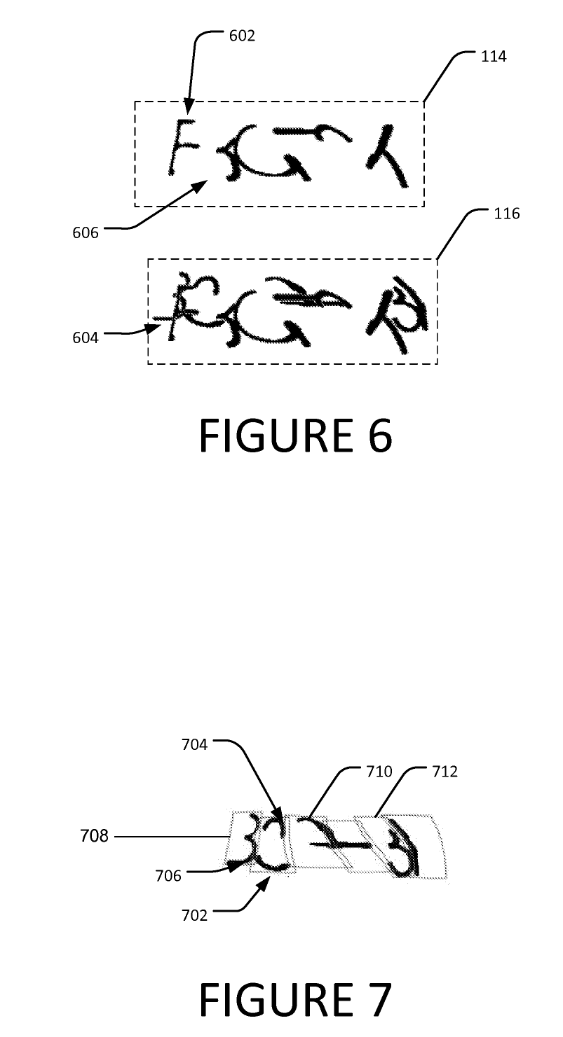

FIG. 6 shows an example of two resulting partial images, i.e., the first partial image 114 and the second partial image 116.

The computing system 110 may randomly or pseudo-randomly partition the segments into either the first partial image 114 or the second partial image 116. The computing system 110 may also partition neighboring segments into different images. For example, a segment 602, a segment 604, and a segment 606 are neighboring segments. They are parts of the neighboring characters “B” and “3.” In the example of FIGS. 1 and 6, the segments 602 and 606 are partitioned into the first partial image 114. The segment 604 is partitioned into the second partial image 116.

The computing system 110 may also use a post-partition process to prevent robots from detecting the splitting points since a cut end may normally appear different from a natural end of a stroke, especially when splitting a stroke with thick width. The computing system 110 may make appearances of the cut ends undistinguishable from natural ends of strokes in the image 112. Therefore, there is no hint for the robots to differentiate a cut end from a natural end. This can be done by stretching out and rounding off the cut end. The computing system 110 may also collect a set of natural ends for the fonts used in generating the characters in the image 112 and fitting them to the cut ends.

At the end of this stage, the computing system 110 may randomly choose one partial image as the background image 118. Alternatively, the computing system 110 may partition one or more long connected segments, such as the segment 602, into a partial image that is to be used as the background image 118. In the example of FIGS. 1 and 6, the computing system 110 uses the first partial image 114 as a background image while continuing to process the second partial image 116 to form the foreground image 120.

Referring back to block 208 of FIG. 2, the computing system 110 partitions segments in the second partial image 116 into multiple groups.

In one example, the computing system 110 groups the segments in the second partial image 116 based on a location of each character in the image 112. This could be the only stage that the computing system 110 uses the prior known information of the character and their locations in the image 112, as the bounding box information of each character shown in FIG. 3, to generate the human user verification test. Due to touching of neighboring characters, the bounding boxes of neighboring characters slightly overlap, as shown in FIG. 3.

FIG. 7 shows an exemplary grouping result of segments in the second partial image 114 by applying the character bounding box information.

In one example, the computing system 110 ensures that the segments from one character are grouped into one group. For instance, segments 702 and 704 both from the character “3” are grouped into a group 708. The computing system 110 may also ensure that segments from connected characters in the image 112 are grouped into one group. The character “B” and the character “3” directly adjacent to B are connected characters in the image 112. The segment of character “B”, i.e., a segment 706, and the segments of character “3,” i.e., the segments 702, is thus grouped into the group 708. Consequently, the segments 702, 704, and 706 are grouped into the group 708.

The computing system 110 defines one or more alignment positions where two or more partial images can be aligned to present at least a portion of the characters in the image 112.

The characters relating to segments in the same group have the same alignment position. In other words, one or more characters are recognizable at the same time when a user aligns the partial images. For example, the character “B” and character “3” whose segments 702, 704, 706 are in the same group 708, are recognizable at the same time when the group 708 is moved to the correct alignment position onto the other segments of the character “B” and “3” in the background image 118.

In one example implementation, the computing system 110 first uses raster scan techniques to find connected foreground pixels in the second partial image 116, and assigns the same value for the connected pixels but different values to disconnected segments. The computing system 110 then finds the different pixel values of the segments in a same character bounding box, except the segments with a distance inside the inner bounding box (the part excluding the overlapping regions with the bounding boxes of the neighboring characters) shorter than a preset threshold while the distance of the segment inside the inner region of the neighboring bounding box is larger than the preset threshold. If a segment is shorter than the preset threshold in both inner regions of the neighboring character bounding boxes, the computing system 110 assigns it to the character that has longer segments in the inner region of the character bounding box. Without the extension of cut ends to form natural ends, it is impossible for the segments of a character to stretch beyond its bounding box. The extension of cut ends make it possible that a segment of a character may stretch into the inner region of a neighboring character, but the portion inside the inner region of the neighboring character is usually very small as compared to the rest of the segment since each segment after cut is constrained to having a length larger than a preset minimum.

These found pixel values may be considered as equivalent and the computing system 110 may replace these values with a single value that is different from existing pixel values. As a result, foreground pixels of connected segments and segments from same characters are assigned with the same pixel value and form a group. Pixels assigned with different values are thus grouped into different groups.

Thus, the computing system 110 obtains three resulting groups, i.e., 708, 710, and 712 as shown in FIG. 7.

Referring back to block 210 of FIG. 2, the computing system 110 forms the foreground image 120 at least partly based on a result of the partitioning.

After having classified the segments in the second partial image 116 into groups, the computing system 102 may further arbitrarily perturb and/or rearrange the locations of these groups. For instance, the computing system 110 may arrange the groups, i.e., 708, 710, and 712, in a circular manner to hide a beginning of the groups in the foreground image 120.

In one example, no segment from one group may occlude any segment from another group. In another example, the segment from one group may touch another segment from another group. If there are N (N can be any positive integer) different groups, the computing system 110 may define a maximum of N different alignment positions. For example, the computing system 110 may change the distances between different groups so that all characters in the image 112 would not be aligned at one alignment position. For another example, the computing system 110 may also combine two or more groups together into a new group. In one example, two groups combined together may be neighboring groups, such as groups 708 and 710 shown in FIG. 7. In another example, two groups combined together may be non-neighboring groups, such as groups 708 and 712 shown in FIG. 7. After combining, segments in a group may be separated by segments from another group. Such combination would result in less than N alignment positions. The characters with the same permutation appear recognizable when the user 102 moves the foreground image 120 against the background image 118. For example, when the computing system 110 combines groups 708 and 712, the characters “B,” “3,” “3,” and “K” are recognized at one alignment position.

The multiple partial images presented to the user 102 may be freely movable in any direction at the user interface 108. Alternatively, one partial image is fixed and another partial image is movable. For instance, the background image 118 is fixed at the user interface 108, and the foreground image 120 is movable onto the background image 118 in one direction (e.g., sliding along a single axis) or circularly.

It is possible that at some misaligned position, a combination of some strokes in the background image 118 and the foreground image 120 form one or more visual objects that look like legitimate characters and therefore the user 102 might be confused. To mitigate this usability problem, the computing system 110 may also perturb some groups together so that at each alignment position, there are at least two recognizable characters. For example, the two recognizable characters may be non-neighbored characters. A combination of groups 708 and 712 is an example. The computing system 110 may provide a hint to the user 102 on the user interface 108 (e.g., informing the user that at least two characters will be visible at each alignment position).

In one example, recognizable characters may be separated by non-recognizable characters so that it is harder for robots to identify two distant recognizable characters separated by cluttering strokes. Ensuring that at least two characters would appear recognizable and informing the user 102 of this fact, such as a hint on the user interface 108, reduces the possibility that a human user will misidentify an alignment position, since the probability is low that two legitimate characters will appear when the partial images are aligned at locations other than the alignment positions.

The segments with the same alignment position in the second partial image 116 may have several cut ends. These cut ends may start to touch the corresponding segments in the background image 118 at one time. This would give the robots a hint of the alignment positions since it is unlikely that arbitrarily arranged segments in one image would start to touch the segments in the other image at several points simultaneously, especially since those touch points are at a small horizontal range.

In one example, to avoid providing this hint to the robots, the computing system 110 may select the potential splitting points to ensure that the selected points spread in a wide range within the image 112. This avoids concentration of splitting points in a small horizontal region. For example, as shown in FIG. 4, the potentially splitting points spread between different characters of “B3GF3K.”

For those splitting points in the second partial image 116 that have the same alignment position, the computing system 110 may extends or shrinks the corresponding segments in the second partial image randomly or arbitrarily in a preset range. This ensures that these splitting points touch the segments in the background image 116 at different locations by moving one partial image against another partial image. The resulting characters, when the two images are correctly aligned, may have some gaps at some splitting points while overlapping at other splitting points. This would not affect human recognition of the characters with properly selected range of adjustment.

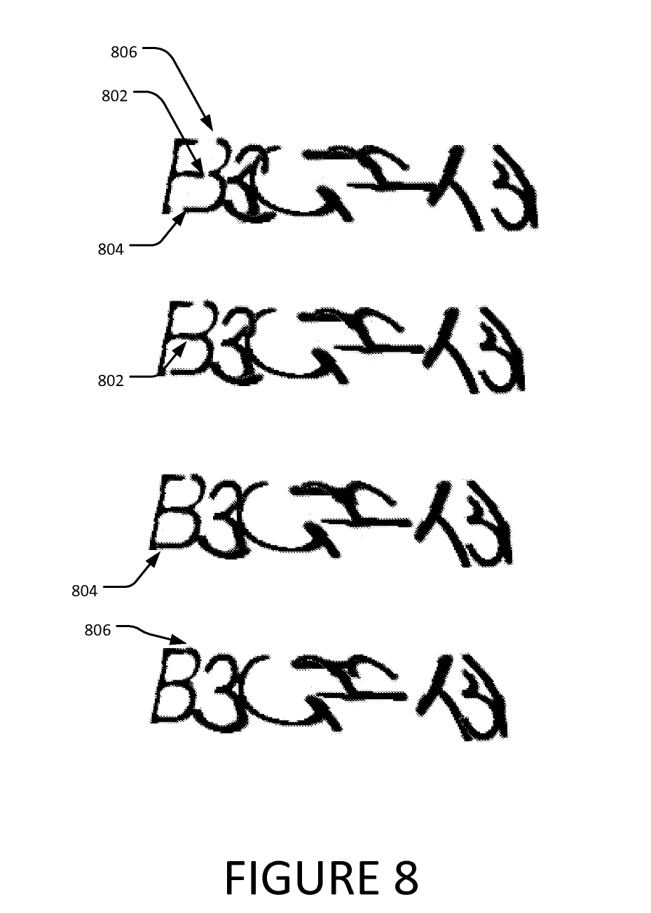

FIG. 8 shows an exemplary result after randomly shrinking or extending the ends of segments of characters. There are three ends of the character “B,” which are indicated by arrows 802, 804, and 806, when segments are aligned to present the character “B.”

As shown in FIG. 8, when the foreground image 120 is aligned with the background image 118 at different positions, the split middle stroke of “B” starts to touch at the end 802, then the split bottom stroke starts to touch at the end 804, and finally the split top stroke starts to touch at the end 806. This avoids the three ends of “B” start to touch at one time. In the example of FIG. 8, character “B” and character “3” is recognizable at the alignment position while the other portions appear unrecognizable visual objects or bogus characters.

In addition, the computing system 110 may rearrange the order of the groups in the second partial image. For example, in the FIG. 7, the groups from left to right are the group 708, the group 710, and the group 712. The computing system 110 may change the relative order among them.

For example, the movement of the foreground image 120 against the background image 118 may be a circular movement. To prevent the robots from knowing the relative order of the groups in the second partial image 116, the computing system 110 may apply a random circular shift that perturbs the relative positions of the groups 706, 708, and 710 in the FIG. 7. The result is output in the foreground image 120.

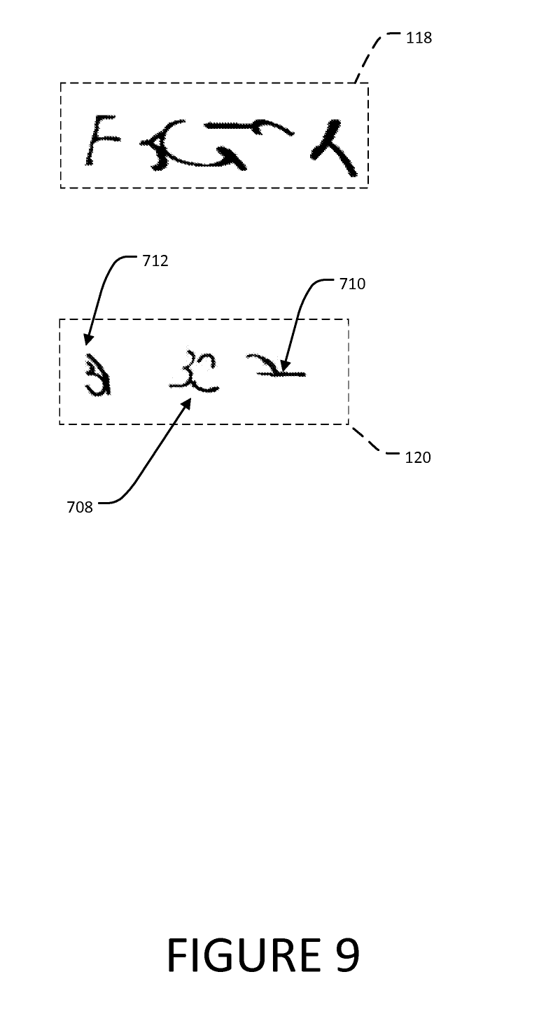

FIG. 9 shows an exemplary result of the first partial image 114 as the background image 118 and the second partial image 116 after processing described above as the foreground image 120. The groups are reordered in the foreground image 120. They are, from left to right, the group 712, the group 708, and the group 710

Referring back to block 212 of FIG. 2, the computing system 110 presents the first partial image 114 as the background image 118 and the second partial image 116 after processing described above as the foreground image 120 to the user 102, and requests the user 102 to align the two partial images at one or more alignment positions to recognize characters.

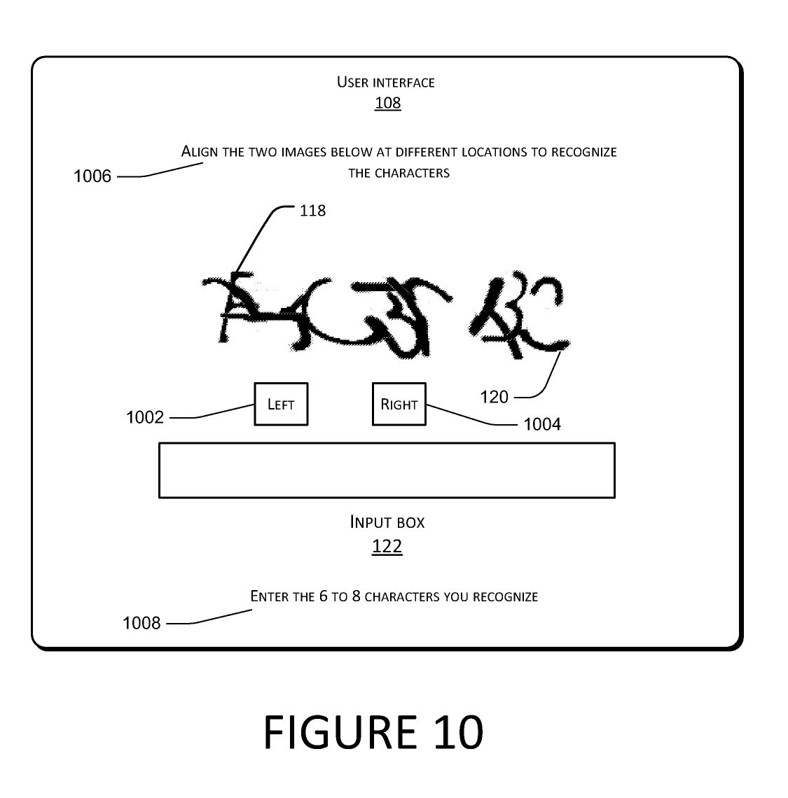

FIG. 10 shows an exemplary display of the human user verification test to the user 102 on the user interface 108.

Both the background image 118 and the foreground image 120 are available to the user 102 on the user interface 108. In one example, some instructions are available to the user 102 on the user interface 108.

In the example of FIG. 10, the background image 118 is static and not movable. However, in some other embodiments, both the background 118 and the foreground image 120 may be movable.

In the example of FIG. 10, the foreground image 120 is movable horizontally in a “circular” (i.e., repeating) manner, such that a portion moved outside a preset range is reintroduced at the other end. In such circular movement, there is no beginning or ending position, and there is always a substantial overlapping region between the two images. The period of the circular horizontal movement may be selected to be the larger horizontal bound of the foreground and background images.

In one example, when there is only one alignment position, the user 102 only needs to move the foreground image 120 onto the background image 118 once to recognize the visual objects 112.

For the example as shown in FIG. 10, there are multiple alignment positions. When the user 102 moves the foreground image 120, the user 102 may recognize different characters at different alignment positions. For example, at a first alignment position, the user recognizes the characters “B” and “3”. At a second alignment position, the user recognizes the characters “G” and “F”. At a third alignment position, the user recognizes the characters “3” and “K.” In the example of FIG. 10, the user also needs to recognize the order of the characters from left to right: “B,” “3,” “G,” “F,” “3,” and “K.”

The user then submits the recognized characters in the input box 122. The recognized characters are returned to the computing system 110.

The computing system 110 compares the user's recognized characters with the characters in the image 110. In an even that the recognized characters match the characters in the image 112, the computing system 110 determines that the user 102 is a human user. The online service is then available to the user 102. Otherwise the computing system 110 determines that the user 102 is probably a robot and the online service is not available to the user. The computing system 104 may allow the user 102 to input the recognized characters a preset number of times if a prior input is wrong.

There are various techniques to improve the usability of the human user verification test and thus the user experiences.

In one example, the user 102 can use a mouse or other pointing device (e.g., stylus, finger, track ball, touch pad, etc.) to move the foreground image 120 and obtain one or more of the characters at each alignment position. In another example, as shown in FIG. 10, there are two buttons 1002 and 1004 on the user interface 108. The user 102 can click the button 1002 to move the foreground image 120 left or click the button 1004 to move the foreground image 120 right.

In some embodiments, the computing system 110 may also provide some directions to the users. For instance, the computing system 104 displays a label 1006 “Align the two images below at different locations to recognize the characters.” The computing system 104 may also give a hint of the characters to be identified. For example, the computing system 104 displays a label 1008 “Enter the 6 to 8 characters you recognize” on the user interface.

To ensure that the superposition of the two images form a natural image, the computing system 110 may present the foreground image 120 in a transparent mode in which the background of the foreground image 120 is transparent. In this way, only the foreground pixels in the foreground image 120 would be used to replace the corresponding pixels in the background image 118, resulting in a desirable superposition effect.

There are several image formats such as graphic interchange format (“GIF”), portable network graphics (“PNG”), and tagged image file format (“TIFF”) supporting transparent representation of an image through either a transparent color or an alpha channel.

For web applications, for example, display of the human user verification test may be easily implemented in hypertext markup language (“HTML”) and JavaScript™. JavaScript™ is supported by many web browsers and can efficiently move an image horizontally in a circular manner.

Some or all of the techniques described in the exemplary embodiment may be used in the other embodiments to the extent applicable. For instance, the exemplary embodiment shows splitting the image 112 into two partial images. In another embodiment, the computing system 110 may split the image 112 into three or more partial images. The computing system 110 may also choose one or more partial images as the background image and one or more partial images as the foreground image. The image may include pictures instead of characters. At multiple alignment positions of the partial image, at least a portion of the pictures are recognizable.

### An Exemplary Computing System

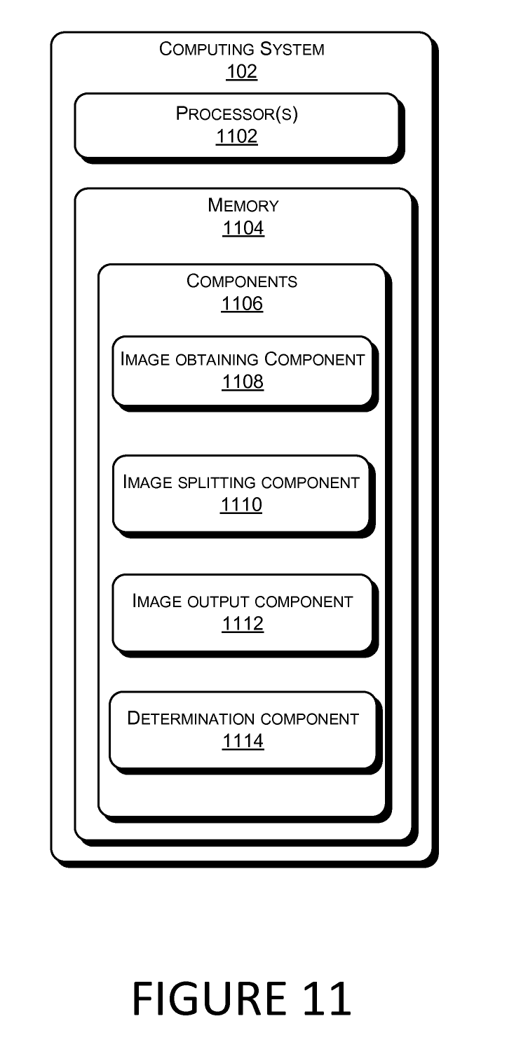

FIG. 11 illustrates an exemplary embodiment of the computing system 110, which can be used to implement the techniques described herein, and which may be representative, in whole or in part, of elements described herein.

Computing system 110 may, but need not, be used to implement the techniques described herein. Computing system 110 is only one example and is not intended to suggest any limitation as to the scope of use or functionality of the computer and network architectures.

The components of computing system 110 include one or more processors 1102, and memory 1104. Memory 1104 may include volatile memory, non-volatile memory, removable memory, non-removable memory, and/or a combination of any of the foregoing.

Generally, memory 1104 contains computer executable instructions that are accessible and executable by the one or more processors 1102.

The memory 1104 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Any number of program modules, applications, or components 806 can be stored in the memory, including by way of example, an operating system, one or more applications, other program modules, program data, computer executable instructions. The components 1106 may include an image obtaining component 1108, an image splitting component 1110, an image outputting component 1112, and a determination component 1114.

The image obtaining component 1108 obtains an image including a plurality of visual objects.

The image splitting component 1110 splits the visual objects into a plurality of partial visual objects, partitions the plurality of partial objects into multiple partial images, and forms one or more alignment positions. At the one or more alignment positions, at least a portion of the visual objects appear. After the multiple partial images are aligned at all of the alignment positions at once, when there is only one alignment position, or at different times, when there are multiple alignment positions, all of the plurality of visual objects can be obtained.

The image outputting component 1112 outputs the multiple partial images. The image outputting component 1112 may further request that the user align the partial images to recognize the visual objects.

The determination component 1114 determines whether the recognized visual objects match the original visual objects. If the two matches, the determination component 1114 determines that the user 102 is the human user. Otherwise, the determination component 1114 determines that the user 102 is an invalid user.

For the sake of convenient description, the above system is functionally divided into various modules which are separately described. When implementing the disclosed system, the functions of various modules may be implemented in one or more instances of software and/or hardware.

The computing system 110 may be used in an environment or in a configuration of universal or specialized computer systems. Examples include a personal computer, a server computer, a handheld device or a portable device, a tablet device, a multi-processor system, a microprocessor-based system, a set-up box, a programmable customer electronic device, a network PC, and a distributed computing environment including any system or device above.

In the distributed computing environment, a task is executed by remote processing devices which are connected through a communication network. In the distributed computing environment, the modules may be located in storage media (which include data storage devices) of local and remote computers. For example, some or all of the above modules such as the image obtaining component 1108, the image splitting component 1110, the image output component 1112, and the determination component 1114 may be located at one or more locations of the memory 1104.

Some modules may be separate systems and their processing results can be used by the computing system 110.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

We claim:

1. A method performed by one or more processors configured with computer executable instructions, the method comprising:
obtaining an image including one or more visual objects; and
splitting the one or more visual objects into multiple partial images, each partial image including a part of the one or more visual objects of the image.

2. A method as recited in claim 1, the method further comprising presenting the multiple partial images to a user at a user interface.

3. A method as recited in claim 2, the method further comprising:
defining an alignment position, at which the one or more visual objects are recognizable;
requesting the user to find the alignment position to align the multiple partial images into one or more recognized visual objects;
comparing the one or more recognized visual objects with the one or more visual objects of the image; and
determining that the user is a human user in response to determining that the one or more recognized visual objects match the one or more visual objects of the image.

4. A method as recited in claim 2, the method further comprising:
defining multiple alignment positions, wherein at each alignment position, a portion of the one or more visual objects appears recognizable while another portion of the one or more visual objects does not appear recognizable;
requesting the user to find each multiple alignment position to align the multiple partial images to reveal a portion of one or more recognized visual objects at each alignment position and to obtain the one or more recognized visual objects according to a combination of the portion of the recognized visual objects at each alignment position;
comparing the one or more recognized visual objects with the one or more visual objects of the image; and
determining that the user is a human user in response to determining that the one or more recognized visual objects match the one or more visual objects of the image.

5. A method as recited in claim 1, wherein the one or more visual objects comprise:
one or more characters; or
one or more pictures.

6. A method as recited in claim 1, wherein the one or more visual objects are arranged horizontally, vertically, or radially around a ring in the image.

7. A method performed by one or more processors configured with computer executable instructions, the method comprising:
obtaining an image including a plurality of characters;
locating multiple potential splitting points along strokes of the plurality of characters; and
splitting the image into a plurality of partial images at least partly based on the multiple potential splitting points.

8. A method as recited in claim 7, wherein the locating potential splitting points comprises:
thinning strokes of the plurality of characters; and
choosing the potential splitting points including:
one or more connection points where two or more strokes connect or cross each other; and
one or more qualified non-connection points that are internal points of the strokes that do not cross another stroke, the internal points having curvatures greater than a predetermined threshold or run length distances from a most adjacent splitting point larger than a predetermined threshold.

9. A method as recited in claim 7, wherein the plurality of partial images includes a first partial image and a second partial image; and the method further comprising;
using a first partial image as a background image;
using a second partial image as a foreground image; and
defining one alignment position to align the background image and foreground image to recognize the plurality of characters included in the image.

10. A method as recited in claim 7, wherein the plurality of partial images includes a first partial image and a second partial image; and the method further comprising;
using the first partial image as a background image;
partitioning segments in the second partial image into multiple groups;
forming a foreground image at least partly based on the partitioning; and
defining multiple alignment positions to align the background image and foreground image to recognize the plurality of characters included in the image.

11. A method as recited in claim 10, wherein the splitting the image into the plurality of partial images comprises:
selecting multiple potential splitting points;
selecting a group of points from the multiple potential splitting points;
cutting at the group of splitting points; and
partitioning segments resulting from the cutting into the first partial image and the second partial image.

12. A method as recited in claim 10, further comprising:
making appearance of one or more cut ends resulting from the cutting indistinguishable from natural ends of strokes of the plurality of characters in the image.

13. A method as recited in claim 10, wherein the cutting the group of points comprises:
cutting the one or more connection points in a direction that results in two dissimilar segments among multiple alternative directions.

14. A method as recited in claim 10, wherein the partitioning segments in the second partial image into multiple groups comprises:
grouping segments from strokes of one character into one group; and
grouping segments where characters in the image are connected into one group; and
arranging the groups to form of the multiple alignment positions for the background image and the foreground image,
wherein:
segments in one group have a same alignment position to recognize one or more characters in the image.

15. A method as recited in claim 10, wherein the forming the foreground image at least partly based on the partitioning comprises perturbing and/or re-arranging locations of the multiple groups in the foreground image.

16. A method as recited in claim 10, wherein the forming the foreground image at least partly based on a result of the partitioning comprises extending or shrinking one or more cut ends of the segments to avoid the one or more cut ends of segments in one group of the second partial image touching the one or more cut ends of segments in the background image at an alignment position.

17. A method as recited in claim 10, further comprising:
presenting the background image and foreground image to a user through a user interface; and
requesting the user to align the foreground image with the background image to return one or more recognized characters.

18. A method as recited in claim 17, wherein:
the foreground image is circularly movable around the background image; and
one or more characters in the image are recognizable when the foreground image moves against the background image at one of the multiple alignment positions.

19. A method as recited in claim 17, further comprising:
comparing the returned one or more characters with the one or more characters in the image; and
determining that the user is a human user in response to determining that the one or more returned characters match the one or more characters in the image.

20. A computer-implemented system for human user verification, the computer-implemented system comprising:
memory having stored therein computer executable components; and
a processor to execute the computer executable components comprising:
an image obtaining component to obtain an image including one or more visual objects;
an image splitting component to split the one or more visual objects into a plurality of partial visual objects, to partition the plurality of partial objects into multiple partial images, to define one or more alignment positions, wherein at least a portion of the plurality of visual objects becoming recognizable at each of the one or more alignment positions when one or more of the partial images are aligned;
an image outputting component to output the partial images and to request a user to find the one or more alignment positions to return a recognized one or more visual objects; and
a determination component to determine whether the returned one or more recognized visual objects match the one or more visual objects in the image, and to determine that the user is a human user in response to determining that the returned one or more recognized visual objects match the one or more visual objects in the image.
